(19) United States
(12) Patent Application Publication
(10) Pub. No.: US 2012/0257684 A1
(43) Pub. Date: Oct. 11, 2012

(54) METHOD FOR NON-VERBALLY SHARING INFORMATION BETWEEN PERSONS ASSOCIATED WITH THE CONTROL OF AN AIRCRAFT USING A DIGITAL COMMUNICATION LINK

(75) Inventors: Jiri Vasek, Brno (CZ); Petr Krupansky, Veverska Bityska (CZ); Pavel Kolcarek, Brno (CZ); Jaroslav Jonak, Brno (CZ)

(73) Assignee: HONEYWELL INTERNATIONAL INC., Morristown, NJ (US)

(21) Appl. No.: 13/083,070

(22) Filed: Apr. 8, 2011

(51) Int. Cl. H04L 27/00

(52) U.S. Cl. 375/259

(57) ABSTRACT

In a first embodiment, the method includes, but is not limited to receiving a first instruction from a first party who is associated with control of the aircraft, to transmit an initial non-verbal communication to a second party who is associated with control of the aircraft. The method further includes transmitting the initial non-verbal communication to the second party over the digital communication link. The method further includes receiving a second instruction from the second party to transmit a non-verbal response to the initial non-verbal communication. The method still further includes transmitting the non-verbal response to the first party over the digital communication link. Either the initial non-verbal communication or the non-verbal response includes data that can be used to derive a text message and a graphic image, and wherein the graphic image includes information that is available to only one of the first party and the second party.

### TECHNICAL FIELD

The present invention generally relates to air traffic control and more particularly relates to a method for non-verbally sharing information between a pilot and a controller using a digital communication link.

### BACKGROUND

Current air traffic management systems are beginning to utilize digital communication links (e.g., a data link) to facilitate non-verbal communications between a controller and a pilot. Using current digital navigation links, a pilot and a controller (e.g., a tower controller and an air traffic controller) may exchange text messages. When used together with voice communications, such digital communication links provide a useful means to supplement the exchange of information between a pilot and a controller that would otherwise have to be exchanged verbally.

Air traffic management systems are beginning to move towards a model where there will be a reduced reliance on, if not an outright elimination of, verbal communication between a controller and a pilot and a consequential increased reliance on digital syndication links that employ non-verbal digital transmissions to exchange information. For example, it is anticipated that a pilot and a controller will send and receive clearances non-verbally using the digital communication link. However, the volume of information that will likely need to be passed between a controller and a pilot as part of such an exchange may be more complicated and/or voluminous than can be reasonably accommodated using current methods for exchanging text messages over a digital communication link.

Additionally, the communications that will be exchanged between a pilot and a controller over the digital communication link may require interactive negotiations. For example, a trajectory change may be proposed by either a controller or a pilot that may not be acceptable to the other. In such circumstances, the pilot and the controller would need to interact with one another to negotiate an acceptable trajectory. Such interactions and negotiations may not be feasible using current methods for exchanging information between the pilot and the controller using a digital communication link.

Accordingly, what is needed is a method for using a digital communication link that facilitates interactive communication between the pilot and the controller when they communicate non-verbally over a digital communication link. What is also needed is a method for using a digital communication link that facilitates the exchange of larger amounts of information and that permits the type of back and forth negotiations between a pilot and the controller that currently occurs verbally.

### BRIEF SUMMARY

Various, non-limiting examples of a method for non-verbally sharing information between persons associated with the control of an aircraft in flight using a digital communication link are disclosed herein.

In a first embodiment, the method includes, but is not limited to receiving a first instruction from a first party who is associated with control of the aircraft, to transmit an initial non-verbal communication to a second party who is associated with control of the aircraft. The method further includes transmitting the initial non-verbal communication to the second party over the digital communication link. The method further includes receiving a second instruction from the second party to transmit a non-verbal response to the initial non-verbal communication. The method still further includes transmitting the non-verbal response to the first party over the digital communication link. Either the initial non-verbal communication or the non-verbal response includes data that can be used to derive a text message and a graphic image, and wherein the graphic image includes information that is available to only one of the first party and the second party.

In a second embodiment, the method includes, but is not limited to, receiving a first instruction from a first party who is associated with control of the aircraft to transmit a non-verbal request to a second party who is associated with control of the aircraft, the non-verbal request relating to control of an aircraft and including data that can be used to derive a first text message and a first graphic image. The method further includes transmitting the non-verbal request to the second party over the digital communication link. The method further includes receiving a second instruction from the second party to transmit a non-verbal response to the non-verbal request, the non-verbal response relating to control of the aircraft and including data that can be used to derive a second text message and a second graphic image. The method still further including transmitting the non-verbal response to the first party over the digital communication link. One of the first graphic image and the second graphic image includes information that is available to only the first party or the second party, respectively.

In a third embodiment, the method includes, but is not limited to transmitting a non-verbal request over the digital communication link between a first party who is associated with control of the aircraft and a second party who is associated with control of the aircraft. The non-verbal request includes data that can be used to derive a text message and a graphic image. The method further includes negotiating a response to the non-verbal request over the digital communication link via an iterative exchange of communication transmissions between the first party and the second party. Each communication transmission includes data that can be used to derive a subsequent text message and a subsequent graphic image. At least one of the subsequent graphic images displays information that is available to only one of the first party and the second party. The method still further includes terminating communication over the digital communication link when negotiations have concluded.

### BRIEF DESCRIPTION OF THE DRAWINGS

The present invention will hereinafter be described in conjunction with the following drawing figures, wherein like numerals denote like elements, and

FIG. 1 is a block diagram illustrating an example of a method for non-verbally sharing information between a first party and a second party associated with control of an aircraft using a digital communication link;

FIG. 2 is a block diagram illustrating another example of a method for non-verbally sharing information between a first party and a second party associated with control of an aircraft using a digital communication link; and

FIGS. 3-8 are depictions of an aircraft navigation screen during negotiation of a trajectory change using the methods depicted in FIGS. 1-2.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

Digital communications links that permit data and other information to be digitally exchanged between pilots and controllers are well-known and, to a limited extent, are currently being used in the exchange of information between parties associated with the control of an aircraft in modern air traffic management systems. As used herein, the term “parties associated with control of an aircraft” shall refer to a party who is one of a pilot of the aircraft, a pilot of another aircraft, a controller, and a worker at an airline operation center. An example of such a digital communication link is disclosed and described in U.S. Publication No. 2010/0250025, submitted by Vasek, et al., (hereinafter “Vasek”), the disclosure of which is hereby incorporated herein by reference in its entirety. Using such a digital communication link, a pilot and a controller may not only exchange text messages with one another, but may also exchange graphic images. For example, a pilot may transmit a graphic image depicted on a navigation display screen in the cockpit of the pilot's aircraft to a controller over the digital communication link. Once the graphic image has been received, the controller can view the graphic image on a display screen in the control tower or control facility. The ability to exchange graphic images in addition to text messages permits a pilot and the controller to share relatively large amounts of information with one another very quickly and a format that is easy to comprehend. By transmitting graphic images to one another, the pilot and the controller can accomplish silently what previously had been accomplished through a relatively protracted verbal exchange.

Such digital communication links make it possible to transform current air traffic management systems, which rely heavily on verbal communication between a controller and a pilot, to a system that has a greatly diminished reliance on verbal communications. In some implementations, the exchange of verbal communications between a pilot and a controller may be altogether eliminated. Such systems will require new methods of engagement and interaction between the pilot and a controller to permit the non-verbal sharing of information. A greater understanding of a method for non-verbally sharing information between a pilot and a controller using a digital communication link may be obtained through a review of the illustrations accompanying this application together with a review of the detailed description that follows.

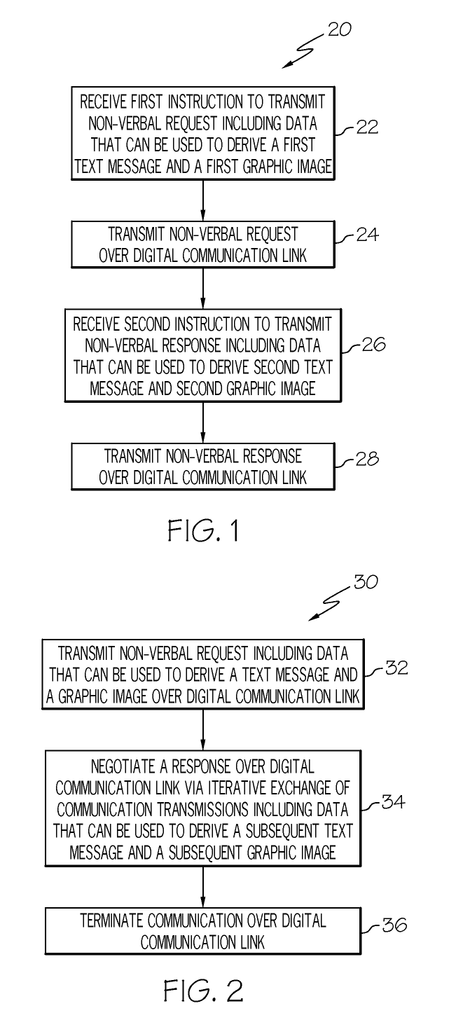

FIG. 1 is a block diagram illustrating an embodiment of a method 20 for non-verbally sharing information between a first party associated with control of an aircraft and a second party associated with control of the aircraft using a digital communication link. While the digital communication link disclosed in Vasek is a suitable medium that enables performance of the methods described below, it should be understood that Vasek is merely exemplary and that any other suitable system that permits the digital exchange of information may also be employed. Method 20 may be employed by a first party and a second party participating in an air traffic management system during any phase of the flight of an aircraft, including both ground-based and airborne phases. It will be understood by those of ordinary skill in the art that, although the context of the discussion contained herein is with respect to air traffic management, the methods disclosed herein may be employed by any two parties communicating over a digital communication link.

At block 22, a first instruction is received at a component of a digital communication link when the first party engages with the component. The first party's component may be a touch screen display, a computer terminal, or another device or combination of devices that are coupled with the digital communication link and that is/are configured to enable the first party to engage with the digital communication link for the purposes of transmitting, receiving, and/or reviewing a non-verbal request.

The non-verbal request may include both a first text message and a first graphic image. For example, in a scenario where a pilot requests a change in the trajectory of the aircraft's flight path (e.g., a change in the aircraft's altitude, heading or speed), the non-verbal request may include a text message that briefly states what is desired while the graphic image may contain additional information that helps to understand the non-verbal request. For instance, the text message may simply state “trajectory change requested” while the graphic image may depict the current trajectory of the aircraft in a first color and the proposed new trajectory of the aircraft in a second color. It should be understood that in other embodiments, the initial communication may simply be a status inquiry, an informational broadcast, or a request to initiate communications over the digital communication link. For example, the pilot may ask the controller to identify meteorological conditions that the pilot will encounter along the aircraft's present trajectory (i.e., relevant meteorological conditions). In another example, the pilot may ask the controller to identify air-traffic that may pass within a predetermined distance of the pilot's present trajectory during the pilot's flight (i.e., relevant air traffic). In yet another example, the pilot may ask the controller to share the predicted trajectory (i.e., the trajectory reflected in the flight plan filed with the controller) with the pilot. These requests may be made using text messages alone and may therefore not include a graphic image. Conversely, the response to such requests may include only a graphic image (e.g., a graphic depiction of relevant meteorological conditions or a graphic depiction of relevant air traffic) and may therefore not include a text message.

When engaging with the first party's component, the first party may be presented with a menu or a series of menus on a display screen. Each menu may include multiple choices and/or options for the first party to select. Selection of a menu item may be accomplished by use of a cursor control device, a keyboard, a microphone coupled with voice recognition software, or via any other conventional means. In some embodiments, the selection of the menu item by the first party may cause the first party's component to receive the first instruction.

In some embodiments, the selection of a menu item may relate solely to the text message that the first party wishes to send. In such embodiments, the first party may be required to engage the first party's component further to select the contents of the graphic image to be sent to the second party. For instance, a pilot wishing to request a change in a trajectory may select an appropriate message from a menu of text messages and may also use a cursor control device to draw or otherwise indicate the proposed new trajectory graphically. In this example, the nonverbal request may include both the text message selected by the first party from the menu as well as a complete image of the first party's navigation screen, such complete image showing the proposed modification to the trajectory. In other embodiments, the graphic image portion of the non-verbal request may comprise one or more discreet graphic images that will, when transmitted, be displayed on the second party' screen.

In some embodiments, the mere selection of a menu item and the drawing or selection of a graphic image by the first party will constitute the sending of the first instruction to the first party's component. In other embodiments, the first party may be required to explicitly select a “send” icon or a similar icon before the first party's component will receive the first instruction.

The first instruction instructs the first party's component to transmit a non-verbal request over the digital communication link to the second party. For example, if the pilot initiated the first instruction, then the first instruction will instruct the first party's component to transmit a non-verbal request to the controller. If the controller initiated the first instruction, then the first instruction will instruct the first party's component to transmit a nonverbal request to the pilot.

At block 24, the non-verbal request is transmitted to the second party (either the pilot or the controller, depending upon which party initiated the communication). The non-verbal request is transmitted over the digital communications link using whatever mode of communication that the digital communication link is configured to utilize. Once the non-verbal request has been received by the second party, it will be displayed to the second party on a display screen in their facility. For example, if the communication was initiated by the pilot, then the display screen of the controller would display both text message and the graphic image.

At block 26, a second instruction is received by a component of the digital communication link associated with the second party. The second party's component may be a touch screen display, a computer terminal, or another device or combination of devices that are coupled with the digital communication link and that is/are configured to enable the second party to engage with the digital communication link for the purposes of transmitting, receiving, and/or reviewing a non-verbal communication.

As with the first party, when engaging with the second party's component, the second party may be presented with a menu or a series of menus on a display screen, each menu including one or more choices for the second party to select. The second party may also be enabled to draw graphic images or to select graphic images to be displayed to the first party. Selection of a menu item and/or the drawing of a graphic image and/or the selection of a “send” command (or the like) will cause the second party's component to receive the second instruction.

The second instruction instructs the second party's component to transmit a non-verbal response over the digital communication link back to the first party. The non-verbal response includes both a second text message and a second graphic image. For example, in a scenario where the pilot has requests a change in the trajectory of the aircraft's flight path, the non-verbal response may include a text message that briefly accepts the pilot's proposal (e.g. “Accepted”) while the graphic image may display the new trajectory in a color that indicates that it has been accepted.

In some embodiments, the second party may not be able to respond immediately to the first party's request (or vice versa). In that case, the second party may be able to use the digital communication link to transmit a “standby” message to alert the other party that there may be some delay in receiving a response.

At block 28, the non-verbal response is transmitted to the first party (either the pilot or the controller, depending upon which party initiated the communication). Once the non-verbal response has been received by the first party, it will be displayed to the first party on a display screen in their facility, including, but not limited to the first party's component. For example, if the communication was initiated by the pilot, then the non-verbal response would originate from the controller and the display screen of the pilot would display both text the message and the graphic image included in the controller's non-verbal response.

With respect to the non-verbal request and/or the non-verbal response, the graphic image contained in either or both communications may include information known or available only to one party or the other. For example, in a circumstance where the first party is a pilot requesting a change to the pilot's trajectory and the second party is a controller responding to the request for a change in trajectory, the requests initiated by the pilot will include a graphic depiction of a proposed new trajectory. The inclusion of a graphic depiction of the proposed new trajectory in the request is information that is known only to the pilot prior to the transmission of the request. In response, the controller may reject the pilot's request and include a graphic depiction of relevant air traffic that the pilot would encounter if the pilot's requested change in trajectory were granted. The inclusion of a graphic depiction of relevant air traffic in the response is information that is known only to the controller prior to the response. In this manner, the parties are able to provide one another with much more information than could reasonably and efficiently be conveyed through the use of text messages alone. Additionally, by providing graphic images to one another, each party is enabled to easily and rapidly comprehend not only the request/response itself, but the factual basis underlying the request/response. For this reason, using the example above, the denial of the pilot's request by the controller is not the end of the discussion but rather, it is the beginning of a negotiation.

FIG. 2 is a block diagram illustrating another example of a method 30 for non-verbally sharing information between a first party and a second party associated with control of an aircraft using a digital communication link. With continuing reference to FIG. 1, while method 20 illustrated the various steps for sharing information between a first party and a second party from the perspective of actions taken by the system employing the digital communication link, method 30 illustrates the steps taken by the first party and the second party as they engage in nonverbal communications using the digital communication link.

At block 32, a non-verbal request is transmitted over a digital communication link between the pilot and the controller. The non-verbal request includes both a text message and a graphic image and may be initiated by either the pilot or the controller. Using the example stated above where the pilot seeks permission to change the aircraft's trajectory, the pilot may select, type, or otherwise input an appropriate text message into a display screen, keyboard, or other component of the digital communication link. The pilot may also input an appropriate graphic image that illustrates the change requested to the pilot's current trajectory. The nonverbal request is then transmitted to the controller over the digital communication link.

At block 34, the pilot and the controller negotiate a response to the nonverbal request using the digital communication link. This is accomplished via an iterative exchange of communication transmissions. Each communication transmission includes a subsequent text message and a subsequent graphic image that is input into, and communicated across the digital communication link in the same manner as described above. Depending upon the nature of the request and the circumstances surrounding the response, there may be multiple subsequent text messages and multiple subsequent graphic images exchanged between the pilot and the controller as they transmit messages back and forth over the digital communication link and cooperatively interact in an attempt to share information, understand the other party's circumstances, and find a mutually acceptable solution. At least one of the graphic images exchanged between the pilot and the controller will display information that is available to only one or the other of the pilot and the controller. This ability to share one party's information with the other party permits the pilot and the controller to non-verbally engage in complex negotiations that had previously been handled verbally.

At block 36, after the controller and the pilot have reached a mutually acceptable solution, negotiations will close and communications over the digital communication link will terminate.

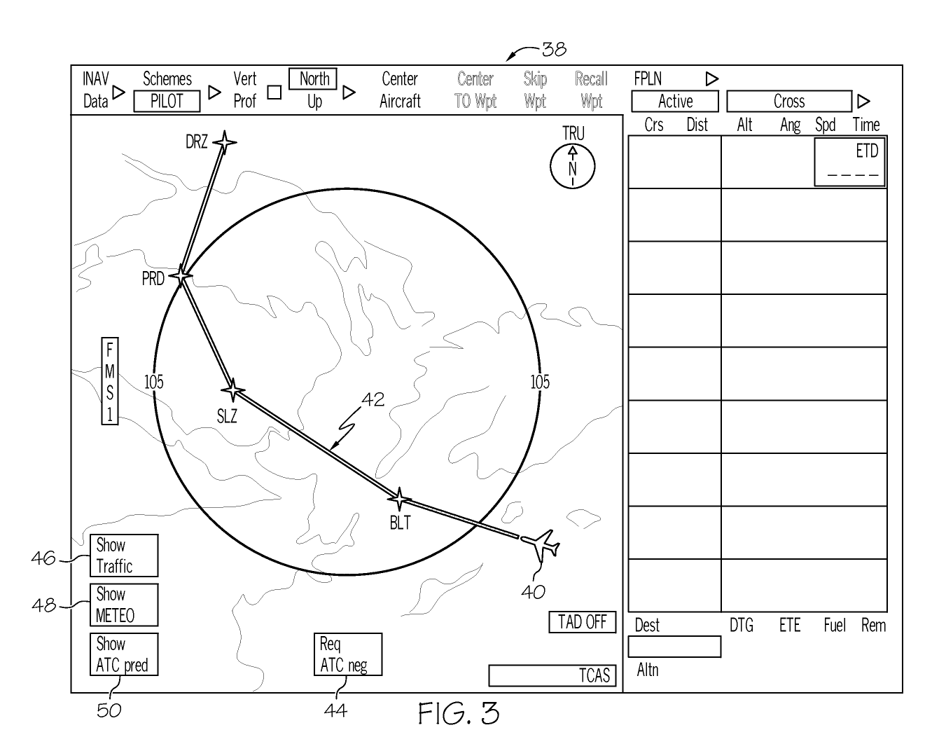

FIGS. 3-8 are depictions of an aircraft navigation screen during an exemplary negotiation of a trajectory change using the methods described above. With continuing reference to FIGS. 1-2, FIG. 3 illustrates a typical air navigation display 38 that presents a top-down, two-dimensional view depicting an aircraft designator 40 (which is representative of the aircraft that the pilot is flying), and a current trajectory designator 42 (which represents the current flight path of the aircraft represented by aircraft designator 40). Current trajectory designator 42 illustrates that currently, the aircraft represented by aircraft designator 40 will pass through several waypoints. Each waypoint is identified by a star-shaped icon and each star-shaped icon has a three letter designator. As indicated in FIG. 3, aircraft designator 40 will pass through waypoint BLT, then through waypoint SLZ, then through waypoint PRD, and finally through waypoint DRZ. At each waypoint, the aircraft represented by aircraft designator 40 will change its heading (and possibly other aspects of its dynamic state such as its velocity, altitude, etc. . . . ) to reach the next waypoint. A ground controller controlling the aircraft represented by aircraft designator 40 may have a similar display at a control facility that depicts not only aircraft designator 40, but designators for every aircraft that the controller is controlling as well as their current trajectories.

Also depicted in air navigation display 38 are additional menu items that are intended to facilitate non-verbal communication between the pilot and the controller. These additional menu items include a negotiation request icon 44, a traffic request icon 46, a weather request icon 48 and a trajectory request icon 50. It should be understood that the illustrated additional menu items are exemplary in nature and are not intended to be limiting. Using a cursor control device, a voice recognition system, a stylus, or any other means for selecting menu items from a display screen, a pilot may select any desired additional menu item.

When selected, negotiation request icon 44 will send a request to the ground controller asking to enter into negotiations regarding some aspect of the flight. For example, the pilot may wish to request a change in trajectory (also referred to as a clearance). When such a request is made, a negotiation using the methods described above would be an appropriate way to address such a request. In other instances, the pilot may simply want to see information that is available to the controller but that is not available to the pilot. This information can include relevant air-traffic, relevant meteorological conditions, and the intended aircraft trajectory that is on file with an appropriate air traffic control agency. The pilot may obtain this information by selecting the appropriate menu item.

Once selected, the request will be transmitted to the controller over the digital communication link. A corresponding message requesting either a negotiation, a presentation of relevant traffic, a presentation of relevant meteorological conditions, or a presentation of the intended aircraft trajectory will be displayed on a display screen in the controller's facility. The controller will have appropriate menu items available on the controller's display screen that will enable the controller to respond to the pilot's request. Additionally, the controller's display screen may have additional menu items that the controller may use to request information that is available to the pilot but which is not available to the controller.

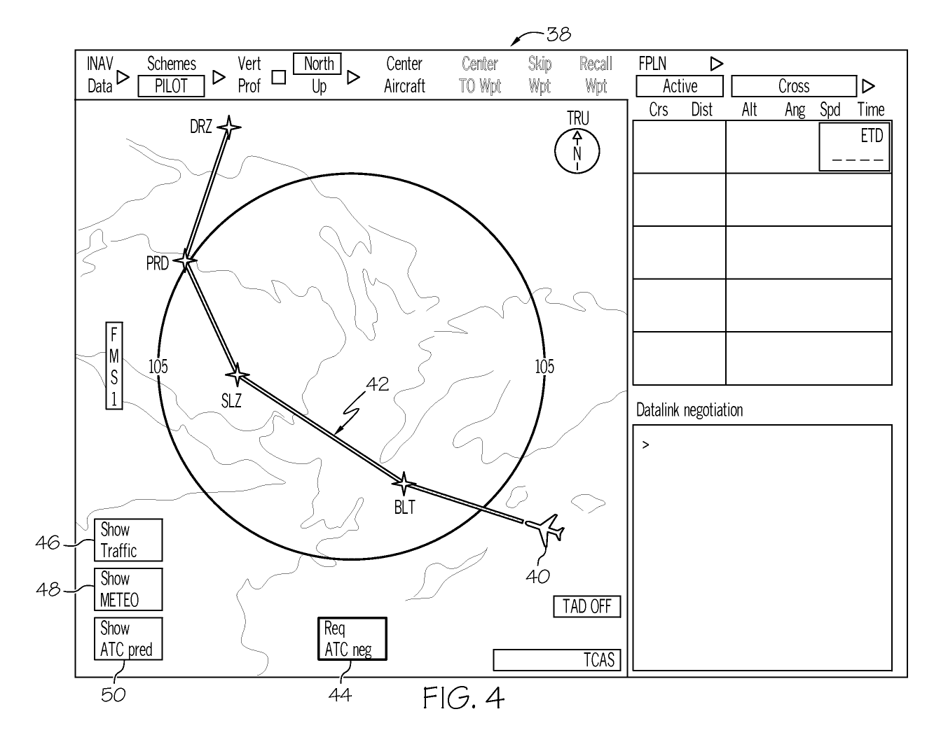

FIG. 4 illustrates air navigation display 38 after the pilot has selected negotiation request icon 44. With continuing reference to FIGS. 1-3, as indicated in FIG. 4, negotiation request icon 44 is illuminated. Once negotiation request icon 44 is selected, a negotiation window 52 opens up in the lower right-hand corner of air navigation display 38. Any text messages exchanged between the pilot and the controller will be displayed in a negotiation window 52. Such text messages may be prepared in any suitable manner including, but not limited to, selecting an appropriate text message from a menu or list of predetermined text messages, typing a desired text message, speaking a desired message into a system employing voice recognition software, or selecting a graphic image for transmission to the controller and having an associated predetermined text message automatically load into negotiation window 52.

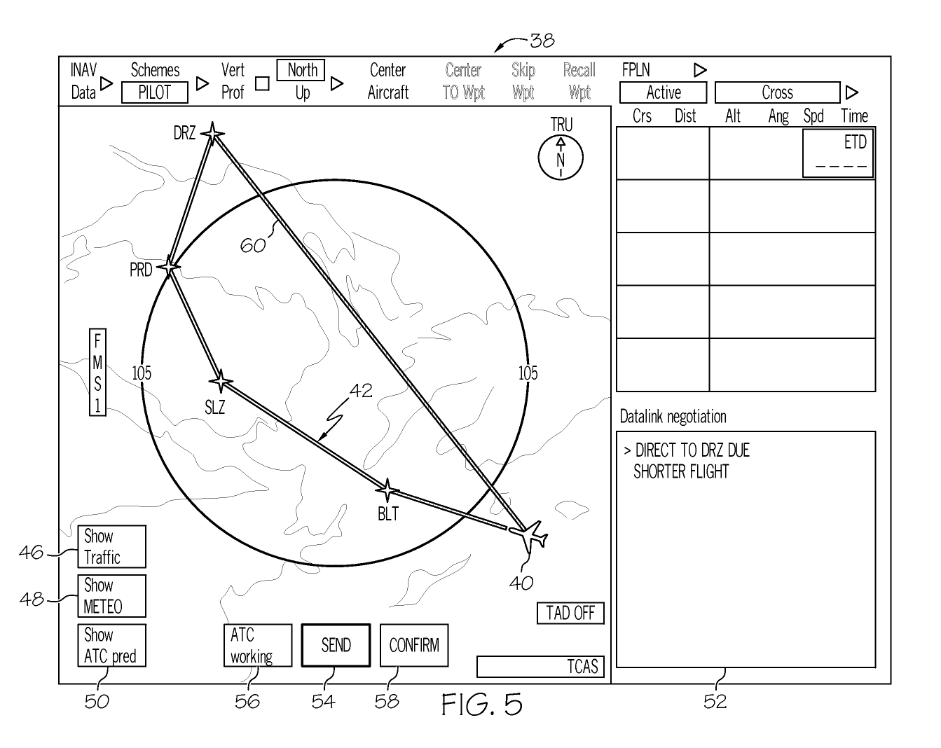

FIG. 5 illustrates air navigation display 38 after the pilot has selected the negotiation request icon. With continuing reference to FIGS. 1-4, negotiation request icon 44 disappears after it is selected and three additional icons appear in air navigation display 38 in generally the same location. In the illustrated example, three new icons have replaced the negotiation request icon 44. These include send icon 54, ATC working icon 56 and confirmation icon 58. Send icon 54 allows the pilot to control the transmission of the text message and the graphic image, if any, to the controller. The pilot will select send icon 54 once the text message appears in negotiation window 52 and the pilot is satisfied that the text message is correct. ATC working icon 56 is controlled by the controller and may be selected by the controller to alert the pilot to the fact that the controller is currently attending to the pilot's pending request. Confirmation icon 58 may be selected by the pilot to close negotiations when a proposal transmitted by the controller is acceptable.

Also illustrated in air navigation display 38 is a graphic image 60 that represents data associated with the negotiation between the pilot and the controller. Graphic image 60 comprises a proposed new trajectory that would route the aircraft represented by aircraft designator 40 from its current location directly to waypoint DRZ, thus bypassing waypoints BLT, SLZ, and PRD. Graphic image 60 appears in a different color than the remainder of current trajectory designator 42. Such color differentiation may assist the controller in discerning the pilot's proposal. Also depicted in air navigation display 38 is a text message that appears in negotiation window 52. The text message, which reads “DIRECT TO DRZ DUE SHORTER FLIGHT” relates to graphic image 60 by stating in words what the pilot wants and why the pilot wants it. Once the pilot has confirmed the that graphic image 60 and the text message that appears in negotiation window 52 adequately and accurately express with the pilot is requesting, the pilot will select send icon 54, which is illuminated in FIG. 5. Once send icon 54 has been selected, graphic image 60 and the text message depicted in negotiation window 52 will appear on the controller's display screen.

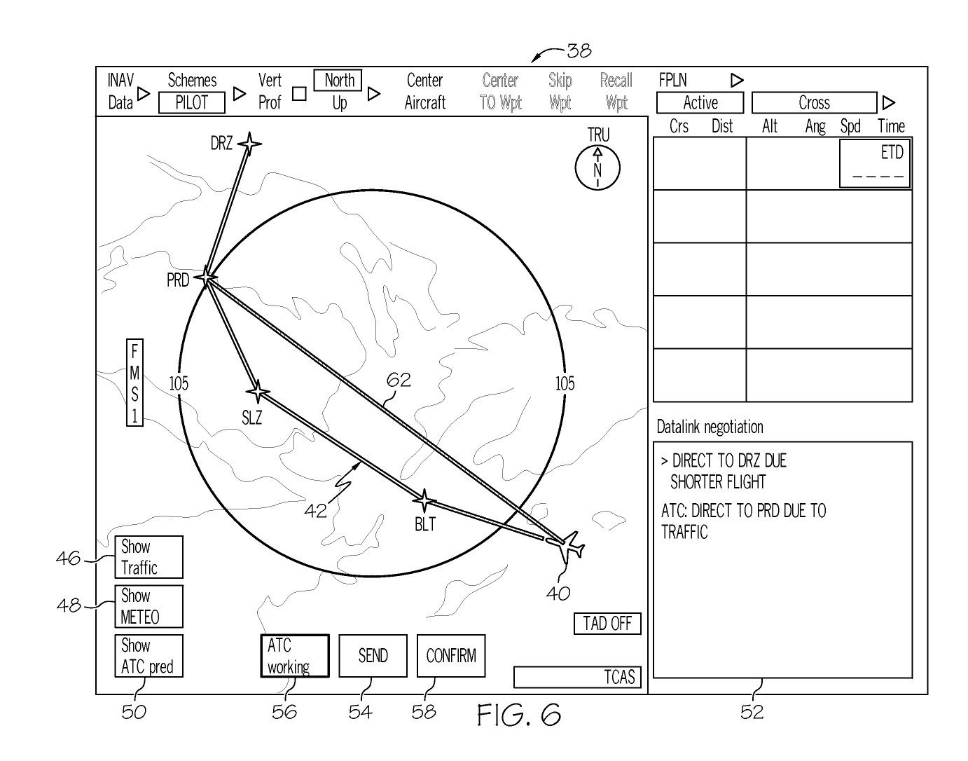

FIG. 6 illustrates the controller's response to the pilot's request. ATC working icon 56 is illuminated to indicate that the controller is currently attending to the pilot's request. Also depicted in air navigation display 38 is a graphic image 62 which comprises the controller's counterproposal to the pilot's request. Graphic image 62 illustrates a trajectory change from the aircraft's current location to waypoint PRD instead of to waypoint DRZ as the pilot had requested. Additionally, a text message from the controller appears in negotiation window 52. The text message provides an explanation for the controller's rejection of the pilot's request. In this example, the controller has declined to alter the aircraft's course directly to waypoint DRZ because of conflicting air-traffic.

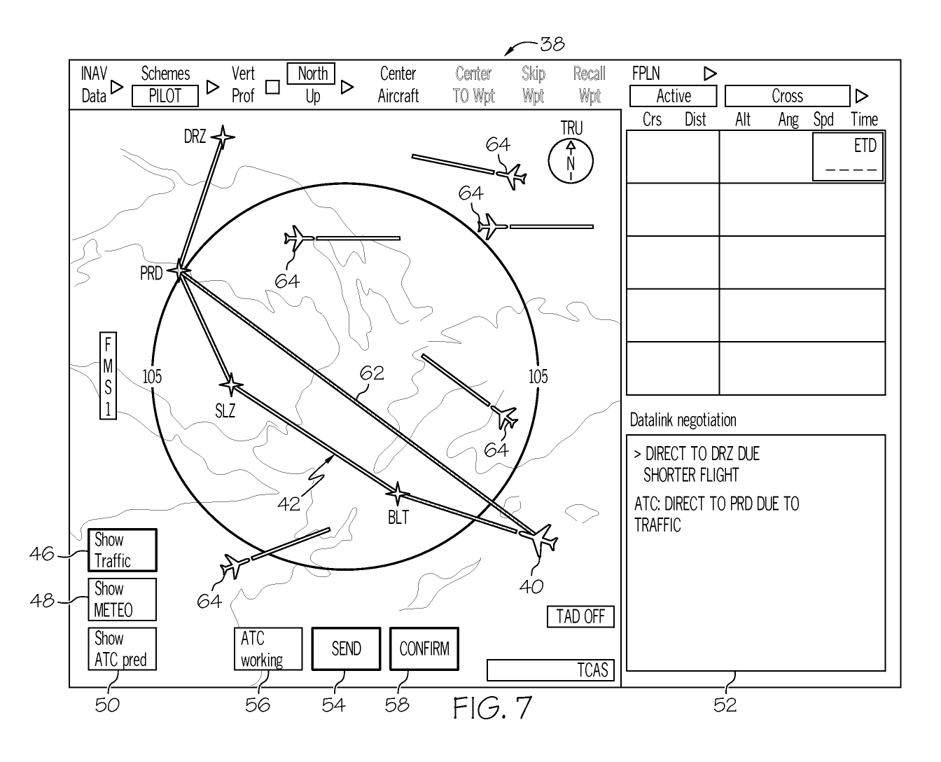

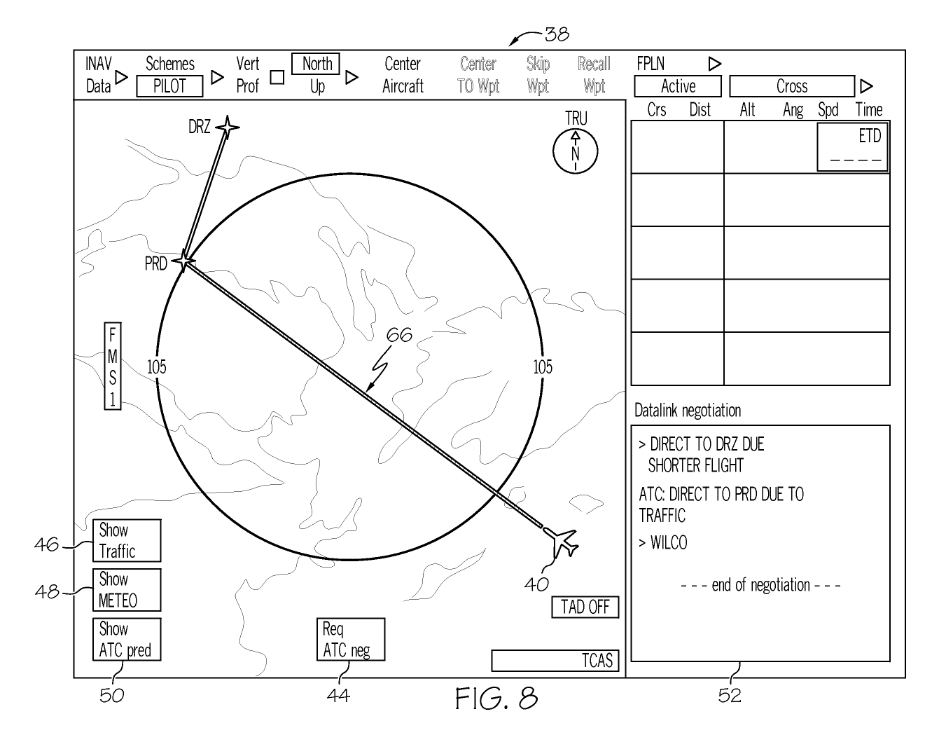

FIG. 7 illustrates the next exchange in the ongoing negotiation between the pilot and the controller. The pilot has selected traffic request icon 46 and in response, the controller has transmitted multiple graphic images 64 depicting relevant air-traffic that will interfere with the pilot's request to alter the aircraft's trajectory directly to waypoint DRZ. In some embodiments, the controller may transmit multiple graphic images 64 spontaneously, without waiting for a request from the pilot to show the traffic. In such embodiments, traffic request icon 46 will also eliminate. In view of the relevant traffic, the pilot agrees that a trajectory change directly to waypoint DRZ would not be appropriate and therefore selects confirmation icon 58 to accept the controller's proposal.

FIG. 8 illustrates the last exchange between the pilot and the controller regarding the pilot's request for a change and directory. With continuing reference to FIGS. 1-7, the text message “WILCO” appears in negotiation window 52. This corresponds with the pilot's selection of confirmation icon 58. Also illustrated in negotiation window 52 is a system message reading “end of negotiation.” This alerts both parties that the request has been addressed and that the subject of the negotiations has been resolved and air navigation display 38 displays new trajectory 66 which shows that the aircraft is now routed directly to waypoint PRD. Negotiation request icon 44 has returned and may be selected by the pilot to initiate a new negotiation.

As illustrated in FIGS. 3-8, the methods described above may be used by both pilot and controller to non-verbally engage in complex negotiations, such as the negotiation of a new trajectory. Their exchange was greatly facilitated by each party's ability to transmit graphic images showing information available only to the transmitting party. For example, the pilot's request for a change and directory included a graphic image (graphic image 60) that illustrated the new route that the pilot wanted to follow. This greatly facilitated the controller's ability to comprehend the request by graphically illustrating for the controller precisely where the pilot wanted to go. Without this visual aid, the controller would have had to dedicate far more time to assessing the pilot's request because the controller would have had to first locate aircraft designator 40 on the controllers display screen and then find waypoint DRZ. The graphic image provided by the pilot eliminated the controller's need to do all of that and instead allowed the controller to immediately focus on the pilot's request. Similarly, by providing the pilot with multiple graphic images 64 showing relevant air-traffic that would conflict with the pilot's request, the pilot gained a better understanding of the controller's refusal to grant the pilot's request. Rather than ending there, the pilot in the controller were able to further negotiate an alternate trajectory (graphic image 62) that achieved the pilot's goal of shortening the route and that achieved the controller's goal of avoiding a conflict with relevant traffic. This negotiation was greatly facilitated by the ability of each party to transmit graphic images together with text messages. This allowed each party to share information with the other that the other lacked.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for non-verbally sharing information between persons associated with control of an aircraft using a digital communication link, the method comprising the steps of:
receiving a first instruction from a first party who is associated with control of the aircraft, to transmit an initial non-verbal communication to a second party who is associated with control of the aircraft;
transmitting the initial non-verbal communication to the second party over the digital communication link;
receiving a second instruction from the second party to transmit a non-verbal response to the initial non-verbal communication; and
transmitting the non-verbal response to the first party over the digital communication link,
wherein either the initial non-verbal communication or the non-verbal response includes data that can be used to derive a text message and a graphic image, and wherein the graphic image includes information that is available to only one of the first party and the second party.

2. The method of claim 1, wherein the step of receiving the first instruction comprises detecting a selection of a menu item by the first party.

3. The method of claim 1, wherein the information that is available to only the one of the first party and the second party comprises a representation of meteorological conditions.

4. The method of claim 3, wherein the representation of meteorological conditions includes only relevant meteorological conditions.

5. The method of claim 1, wherein the information that is available to only one of the first party and the second party comprises a representation of air traffic.

6. The method of claim 5, wherein the representation of air traffic includes only relevant air traffic.

7. The method of claim 1, wherein the information that is available to only the one of the first party and the second party comprises a predicted trajectory.

8. A method for non-verbally sharing information between persons associated with the control of an aircraft using a digital communication link, the method comprising the steps of:
receiving a first instruction from a first party who is associated with control of the aircraft to transmit a non-verbal request to a second party who is associated with control of the aircraft, the non-verbal request relating to control of an aircraft and including data that can be used to derive a first text message and a first graphic image;
transmitting the non-verbal request to the second party over the digital communication link;
receiving a second instruction from the second party to transmit a non-verbal response to the non-verbal request, the non-verbal response relating to control of the aircraft and including data that can be used to derive a second text message and a second graphic image; and
transmitting the non-verbal response to the first party over the digital communication link,
wherein one of the first graphic image and the second graphic image includes information that is available to only the first party or the second party, respectively.

9. The method of claim 8, wherein the step for receiving the first instruction comprises detecting a selection of a menu item by the first party.

10. The method of claim 8, wherein the information that is available to only the first party or the second party comprises a representation of meteorological conditions.

11. The method of claim 10, wherein the representation of meteorological conditions includes only relevant meteorological conditions.

12. The method of claim 8, wherein the information that is available to only the first party or the second party comprises a representation of air traffic.

13. The method of claim 12, wherein the representation of air traffic includes only relevant air traffic.

14. The method of claim 8, wherein the information that is available to only the first party or the second party comprises a predicted trajectory.

15. The method of claim 8, wherein the non-verbal request comprises a request for a change of a trajectory.

16. The method of claim 8, wherein the non-verbal request comprises a request for meteorological conditions.

17. The method of claim 8, wherein the non-verbal request comprises a request for identification of air traffic.

18. The method of claim 8, wherein the non-verbal request comprises a request for a predicted trajectory.

19. A method for non-verbally sharing information between persons associated with control of an aircraft using a digital communication link, the method comprising:
transmitting a non-verbal request over the digital communication link between a first party who is associated with control of the aircraft and a second party who is associated with control of the aircraft, the non-verbal request including data that can be used to derive a text message and a graphic image;
negotiating a response to the non-verbal request over the digital communication link via an iterative exchange of communication transmissions between the first party and the second party, each communication transmission including data that can be used to derive a subsequent text message and a subsequent graphic image, at least one of the subsequent graphic images displaying information that is available to only one of the first party and the second party; and
terminating communication over the digital communication link when negotiations have concluded.

20. The method of claim 19, wherein the non-verbal request is made by using a cursor control device to select the graphic image on a display screen.
